(19) United States
(12) Patent Application Publication
(10) Pub. No.: US 2005/0227751 A1
(43) Pub. Date: Oct. 13, 2005

(54) Video game contest

(76) Inventors: Edward J. Zanelli, San Mateo, CA (US); Mike Musson, Carpinteria, CA (US)

Correspondence Address: Mark D. Wieczorek;c/o Mayer Fortkort & Williams, 251 North Avenue West, Westfield, NJ, 07090, US

(21) Appl. No.: 11/086,876

(22) Filed: Mar. 22, 2005

Related U.S. Application Data
(60) Provisional application No. 60/555,143, filed on Mar. 22, 2004.

(51) Int. Cl. G06F 17/00; G06F 19/00

(52) U.S. Cl. 463/1

(57) ABSTRACT

The invention is directed to methods of organizing video game contests. Implementations of the invention may include one or more of the following aspects. A predetermined number of game scores may be recorded, the scores being results of a video game, from a plurality of players. A number may be posted corresponding to the predetermined number of game scores on a leaderboard, wherein the leaderboard includes a set number of the top scoring of the plurality of players. On a separate leaderboard, an overall number may be posted which is calculated in part by the numbers posted each day in the multiday contest. The leaderboard may be updated over the duration of the video game contest. The recording and posting may be performed every day for a predetermined number of days in a multiday contest. The posting may only occur if the predetermined number of game scores exceeds a minimum threshold. The leaderboard may represent a set of top scores in the video game contest.

### CONTINUING INFORMATION

This application claims priority benefit of U.S. Provisional Patent Application Ser. No. 60/555,143, filed Mar. 22, 2004, entitled “VIDEO GAME CONTESTS”.

### BACKGROUND OF THE INVENTION

Typically, scoring for running contests employs one of two methods—single play or multiple play, where for the latter the sum of all scores becomes the player's score.

In the case of single play contests, usually the game system creates a virtual contest where the players do not necessarily play contemporaneously. One player may play today, another tomorrow, and a third may play several weeks from now. Therefore, the player is not aware of whether they won at the conclusion of their play. And in some cases the player may not even know their standing after they finish playing. The fact that they may need to wait several weeks to find out whether they won may dissuade them from continuing to play.

In the case of multiple play contests, these are typically only for fun and not for prizes. Additionally, there is usually only a total score. This means that if a player becomes aware of a contest only after it has begun, they are at a disadvantage. Furthermore, they may be dissuaded from playing because they may believe that other players will have more available time, creating another perceived disadvantage.

### SUMMARY OF THE INVENTION

The invention is directed to methods of organizing video game contests. Implementations of the invention may include one or more of the following aspects. A predetermined number of game scores may be recorded, the scores being results of a video game, from a plurality of players. A number may be posted corresponding to the predetermined number of game scores on a leaderboard, wherein the leaderboard includes a set number of the top scoring of the plurality of players. On a separate leaderboard, an overall number may be posted which is calculated in part by the numbers posted each day in the multiday contest. The leaderboard may be updated over the duration of the video game contest. The recording and posting may be performed every day for a predetermined number of days in a multiday contest. The posting may only occur if the predetermined number of game scores exceeds a minimum threshold. The leaderboard may represent a set of top scores in the video game contest.

### BRIEF DESCRIPTION OF THE DRAWINGS

FIG. 1 shows a “leaderboard”, indicating the contest high score leaders at a point in time.

FIG. 2 shows a leaderboard indicating the contest high score leaders for a single day.

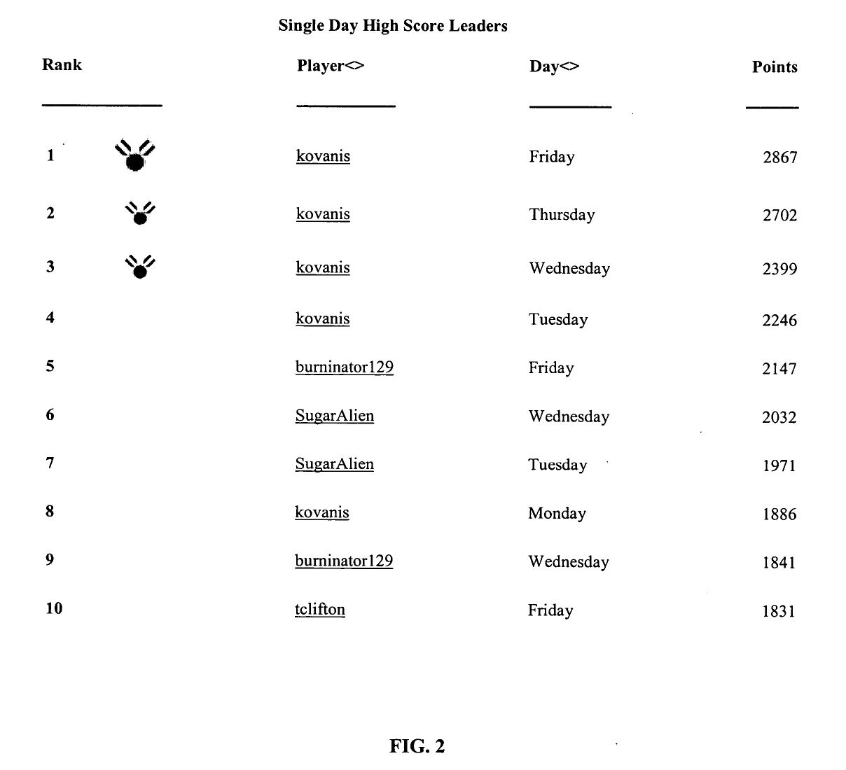

FIG. 3 shows a leaderboard indicating the contest high score leaders for a single game.

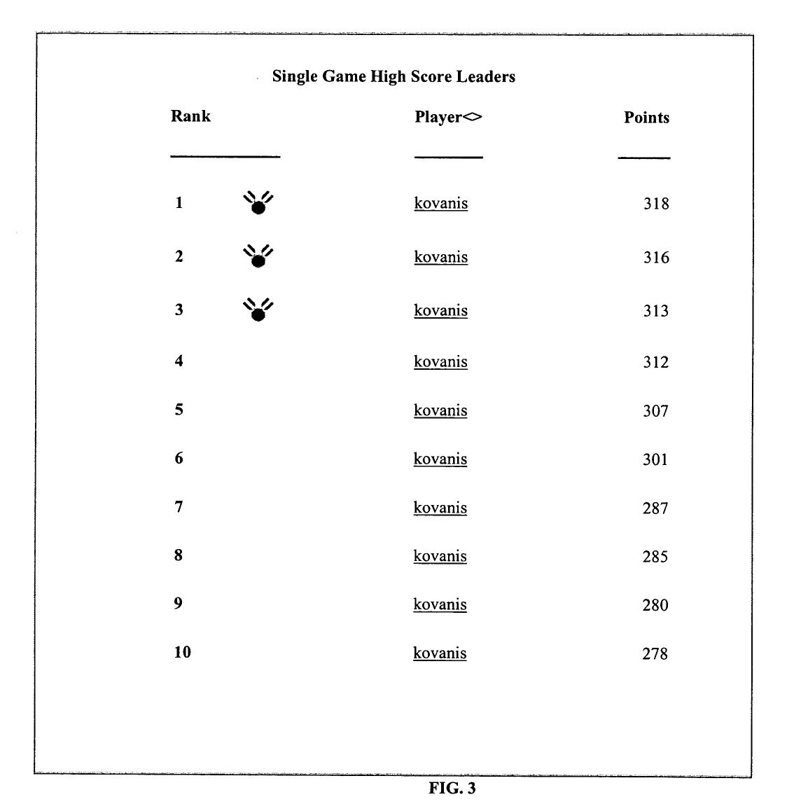

### DETAILED DESCRIPTION

In the present invention, multiple scenarios are employed for players to win. For instance, in a “WordMine” Challenge, there are 4 prize categories: Contest High Score, Single Day High Score, Single Game High Score and Random Drawing.

In this contest, players may be allowed to play as much as they like. The duration of the contest is, e.g., 5 days. Only the top, e.g., 10, scores are saved each day, so the player may believe that there is a point of diminishing returns for continuing to play. Contest High Score refers to the summation of the player's 5 single day scores. Each single day score may be the summation of each player's top 10 scores. Each player may have a set number, e.g., 5, single day scores. These will be ranked with the other players' single day scores. Single Game High Score refers to all individual game score rankings. There may also be established a minimum participation threshold of, e.g., 10 games per day. All players who have achieved that minimum threshold will be eligible for, e.g., a random drawing.

Several prizes may be awarded per category, and limits may be placed, such as only one prize per player.

Leaderboard/Alert Engine

The leaderboard is analogous to a professional golf leaderboard. It may be thought of in terms of, say, a tennis ladder or chess ladder. In these contests, each player may play one or many games. Creating a database schema to capture and retrieve this data is within the purview of a routineer database programmer. A more complicated task is to be able to have the system recognize when players move in or out of the top n spots in the leaderboard and to do so in a rapid fashion. Doing one without the other may be deleterious.

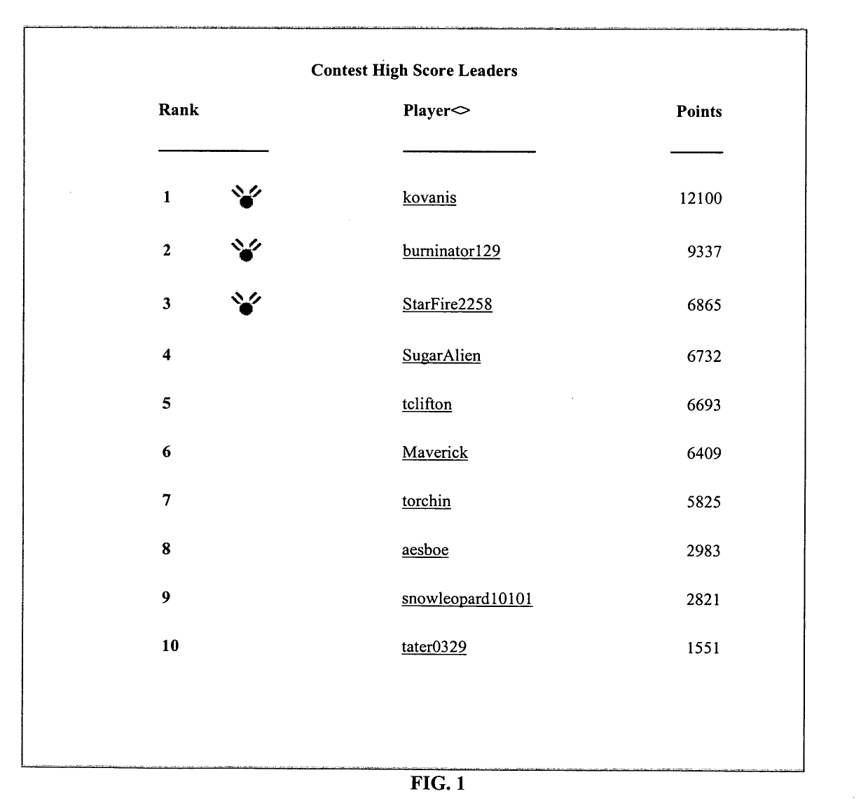

For examples, one leaderboard may appear as in FIG. 1.

In an exemplary embodiment (where all numeric values can be changed as parameters), the top 3 scorers are eligible for prizes. The leaderboard may include the top players, e.g., ten in total, (which may include ties) in each category. Every set number of minutes, e.g., 5 minutes, an electronic snapshot of the leaderboard may be taken and saved. Then the current leaderboard may be compared to the previous leaderboard. For each player who has moved in or out of the leaderboard, an email message is sent. It is possible to move into one leaderboard category, and out of another. The player may receive all of his/her information in one email. This email message may be termed an alert.

The player can choose to receive the alert message via email and/or text message to their mobile phone. Alternatively, the player may turn off the alert feature altogether.

Typically, a flurry of activity will occur near the end of a game.

In alternative embodiments, an optional daily message may be sent that indicates the player's current status, i.e., whether or not they are on the leaderboard. This also stimulates game play.

Players may be allowed to indicate other alert preferences, such as a notification if someone scores above a certain score, or a notification if someone beats their high score.

Alternative Scoring Methodologies

In other embodiments, players may score points in multiple ways, including: registering to play (signup); registering to play during or before a certain time; registering to play within a time window (e.g. 2× bonus for points scored between 2 pm and 3 pm); starting a game; accomplishing a task in a game (e.g. free the POWs, solving a puzzle); scoring points in a game, beating a lap time, etc.; scoring points before a certain time; scoring points within a time window; referring other members to register; referring other members to play; referring other members to score points; sending an SMS (or other protocol) message—this relates directly to revenue for a cellular or other mobile telecommunications carrier; causing (or referring) another player to send an SMS message; challenging another player; defeating another player; accomplishing a task before the other player; creating a tournament, competition, or league; inviting or referring members to sign up for a tournament.

There can also be a team dimension. Most anything a single player can do, can also be done by a group of players, such as a team or clan.

Contest-Enablement of Pre-Existing Video Games.

Embodiments of the invention can provide an API (application programmer's interface) that would manage communications between an arbitrary game client and the server.

For example, one game is called WordMine, and is produced by video game developer Bamium. WordMine is a java word puzzle game that was developed to run in a standalone (client only) environment. A program on a server embodying the invention may include a back-end relational database that captures and stores registration info as well as player game scores. The program may be a ranking engine that maintains several categories of real-time rankings, player stats, and alert notifications.

Two significant concerns include: 1. maintaining continuous game play; and, 2) security. If game play is interrupted, the player may not be interested in continuing to play. If security is breached, players may not play if they believe they will not have a fair chance to compete and win. In this discussion the game WordMine is discussed; however, it should be clear that the principles of the invention may be extended to other video games.

Continuity

In one embodiment, all game play occurs on the client. The server may generate a large number of letters and bonuses (i.e. an amount that could not generally be exhausted by a human being) to be placed then send them to the client, if desired encrypted in some way. The client would decrypt the letters then make them available to the player in the usual way. The game would write an encrypted log file to the player's hard drive that would describe the events that occurred during the game. At the end of the game, the log file would be uploaded to the server, decrypted, and recorded in the database. A drawback to this architecture is that it may be relatively easy for a hacker to decrypt the letters (since the decryption algorithm is necessarily on the client) so as to see them all in advance, thereby achieving an advantage over other fair-minded players.

Security

The most secure way to operate the game is to maintain a persistent socket connection between client and server. As the player uses a letter, the server would generate a new letter and send it to the client. The drawback to this architecture is potential discontinuity due to network latency. If the network is busy, the player may have to wait for letters to arrive from the server.

Architecture

One architecture according to an embodiment of the invention is a hybrid of the two above. A “safe” buffer of letters on the client side is maintained, so that in case of a brief communication interruption, game discontinuity will be invisible to the player. The game client is periodically (e.g. every 250 milliseconds) checking to see if it needs letters. If so, it requests and receives them from the server. By providing only a minimal amount of letters to the client, even the clever hacker would have a very modest or perhaps negligible advantage over other players. Also, instead of writing a log file on the client, the client periodically sends “log fragments” that record game events to the server.

In one trial attempt, continuous client-server game play was successfully supported for over 1500 games in one week, with 99.7% uptime. All rendering (user interface, animation, etc.) may be built into the game client by the game developer. Messaging between client and server allow the recordation of all game events, such as to verify game integrity at a later time.

It will be understood that the above description of a “Video Game Contest” has been with respect to particular embodiments of the invention. While this description is fully capable of attaining the objects of the invention, it is understood that the same is merely representative of the broad scope of the invention envisioned, and that numerous variations of the above embodiments may be known or may become known or are obvious or may become obvious to one of ordinary skill in the art, and these variations are fully within the broad scope of the invention. For example, while certain games and technologies have been described herein, other such games and technologies may also be employed. Accordingly, the scope of the invention is to be limited only by the claims appended hereto, and equivalents thereof. In these claims, a reference to an element in the singular is not intended to mean “one and only one” unless explicitly stated. Rather, the same is intended to mean “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present invention is intended to be dedicated to the public regardless of whether the element, component, or method step is explicitly recited in the claims. No claim element herein is to be construed under the provisions of 35 U.S.C. §§ 112, ¶6, unless the element is expressly recited using the phrase “means for”.

1. A method of organizing a video game contest, comprising:
recording a predetermined number of game scores, the scores being results of a video game, from a plurality of players;
posting a number corresponding to the predetermined number of game scores on a leaderboard.

2. The method of claim 1, wherein the number posted corresponds to the average of the scores.

3. The method of claim 1, wherein the number posted corresponds to the sum of the scores.

4. The method of claim 1, wherein the recording and posting are performed every day for a predetermined number of days in a multiday contest.

5. The method of claim 4, further comprising posting an overall number calculated in part by the numbers posted each day in the multiday contest.

6. The method of claim 1, wherein the posting only occurs if the predetermined number of game scores exceeds a minimum threshold.

7. The method of claim 1, wherein the leaderboard includes a set number of the top scoring of the plurality of players.

8. The method of claim 7, further comprising updating the leaderboard over the duration of the video game contest.

9. The method of claim 8, further comprising sending a message to one of the plurality of players if their game scores are such that the player has a number posted on the leaderboard, or if their game scores are such that the player has a number that has been removed from the leaderboard.

10. The method of claim 9, wherein the message is an email, and short text message, or an SMS message.

11. The method of claim 1, wherein the leaderboard represents a set of top scores in the video game contest.

12. The method of claim 11, wherein the leaderboard represents a set of daily top scores in the video game contest.

13. The method of claim 1, further comprising sending a message to one of the plurality of players if another of the plurality of players earns a higher score.

14. The method of claim 1, further comprising adding points to game scores of the plurality of players by awarding points based on a method selected from one of the following: registering to play, registering to play during or before a predetermined time or date, registering to play within a predetermined time window, accomplishing a task in a game, starting a game, scoring points in a game, scoring points before a certain time in a game, scoring points in a predetermined window of time, referring other players to register, referring other players to play, referring other members to score points, sending a message, causing another playing to send a message, challenging another player, defeating another player, accomplishing a task before another player, creating a tournament, competition, or league, inviting other players to sign up for or play in a tournament, competition, or league.

15. The method of claim 1, wherein a group of the plurality of players is formed as a team to accomplish a common goal.

16. The method of claim 1, wherein software running the game play is localized on each player's computer.

17. The method of claim 1, wherein a persistent socket connection is employed between each player's computer and a server running the video game contest.

18. The method of claim 1, wherein software running the game play is partially localized on each player's computer, while the remainder of the software is located on a server running the video game contest.

19. A method of organizing a video game contest, comprising:
recording a predetermined number of game scores, the scores being results of a video game, from a plurality of players;
posting a number corresponding to the predetermined number of game scores on a leaderboard, wherein the leaderboard includes a set number of the top scoring of the plurality of players;
posting an overall number calculated in part by the numbers posted each day in the multiday contest;
updating the leaderboard over the duration of the video game contest;
such that the recording and posting are performed every day for a predetermined number of days in a multiday contest and wherein the posting only occurs if the predetermined number of game scores exceeds a minimum threshold; and
wherein the leaderboard represents a set of top scores in the video game contest.

20. A computer program, residing on a computer-readable medium, for causing a computer to organize a video game contest, the steps of the program causing a computer to:
record a predetermined number of game scores, the scores being results of a video game, from a plurality of players; and
post a number corresponding to the predetermined number of game scores on a leaderboard.
